(19) United States
(12) Patent Application Publication
(10) Pub. No.: US 2025/0312964 A1
(43) Pub. Date: Oct. 9, 2025

(54) MOLDING DEVICE

(71) Applicant: KYORAKU CO., LTD., Kyoto-shi, Kyoto (JP)

(72) Inventors: Ryouta HAYASHI, Nagoya-shi, Aichi (JP); Takurou MATSUDA, Gifu (JP)

(73) Assignee: KYORAKU CO., LTD., Kyoto-shi, Kyoto (JP)

(21) Appl. No.: 18/859,296

(22) PCT Filed: May 18, 2023
(86) PCT No.: PCT/JP2023/018585

§ 371 Date: Oct. 23, 2024

(30) Foreign Application Priority Data
May 23, 2022 (JP) 2022-084083

(51) Int. Cl. B29C 51/02; B29C 51/36; B29L 7/00

(52) U.S. Cl. CPC B29C 51/02; B29C 51/36; B29L 2007/002

(57) ABSTRACT

A molding device incudes a resin sheet forming device, a roller unit, a mold, and a static eliminator. The resin sheet forming device is configured to extrude a resin sheet in a molten state; the roller unit includes first and second rollers; the first and second rollers are configured to rotate in opposite directions while sandwiching the resin sheet so as to feed the resin sheet below the first and second rollers; the mold has a shaping surface to shape the resin sheet; and the static eliminator is configured to eliminate static from the resin sheet at a point after the resin sheet pass through the roller unit but before a bottom edge of the resin sheet reaches a lower end of a molding area of the mold.

### TECHNICAL FIELD

The present invention relates to a molding device.

### BACKGROUND ART

Patent Literature 1 discloses a method of manufacturing a molded body by sandwiching and feeding a resin sheet, extruded from a resin sheet forming device, with a pair of rollers and by shaping the resin sheet using a mold.

### CITATION LIST

### Patent Literature

[Patent Literature 1] Japanese Unexamined Application Publication No. 2019-206162

### SUMMARY OF INVENTION

### Technical Problem

The resin sheet is usually hung down so that it passes through a position several dozens of millimeters from the mold, but problems such as unintended wrinkles forming on the molded body may occur because of the resin sheet unintentionally coming too close to the mold.

The present invention has been made by taking these circumstances into consideration. The present invention provides a molding device that prevents the resin sheet from unintentionally approaching the mold.

### Solution to Problem

According to the present invention, the following inventions are provided.

(1) A molding device comprising a resin sheet forming device, a roller unit, a mold, and a static eliminator, wherein: the resin sheet forming device is configured to extrude a resin sheet in a molten state; the roller unit comprises first and second rollers; the first and second rollers are configured to rotate in opposite directions while sandwiching the resin sheet so as to feed the resin sheet below the first and second rollers; the mold has a shaping surface to shape the resin sheet; and the static eliminator is configured to eliminate static from the resin sheet at a point after the resin sheet passes through the roller unit but before a bottom edge of the resin sheet reaches a lower end of a molding area of the mold.

(2) The molding device according to (1), wherein: the mold comprises a convex part in the molding area.

(3) The molding device according to (2), wherein: when total height of the molding area is H, a top of the convex part is located 0.3H or less from the lower end of the molding area.

(4) The molding device according to (3), wherein: an inclined surface is provided at an upper side of a top of the convex part; and the amount of protrusion of the inclined surface gradually decreases upward.

(5) The molding device according to any one of (2) to (4), comprising a mold frame arranged around the mold, wherein: the mold frame comprises a suctioning surface capable of suctioning the resin sheet, the mold frame is configured to advance toward the resin sheet to suction the resin sheet and then retract relative to the mold to press the resin sheet against the convex part.

(6) The molding device according to any one of (1) to (5), wherein: the roller unit comprises a frame that houses the first and second rollers, and the static eliminator is attached to underside of the frame directly or via other component.

The inventor investigated the cause of the resin sheet coming close to the mold and found that the resin sheet is charged when the resin sheet passes through the first and second rollers, and is attracted to the mold by electrostatic action. Based on this knowledge, they found that eliminating static from the resin sheet after it passes through the first and second rollers enables to prevent the resin sheet from unintentionally coming close to the mold, leading to the completion of this invention.

### BRIEF DESCRIPTION OF DRAWINGS

FIG. 1 shows a molding device of a first embodiment of the present invention.

FIGS. 2A to 2C show a roller unit 2 and a static eliminator 4, and FIG. 2A is a diagonal view from below, FIG. 2B is a bottom view, and FIG. 2C is a C-C cross section in FIG. 2B.

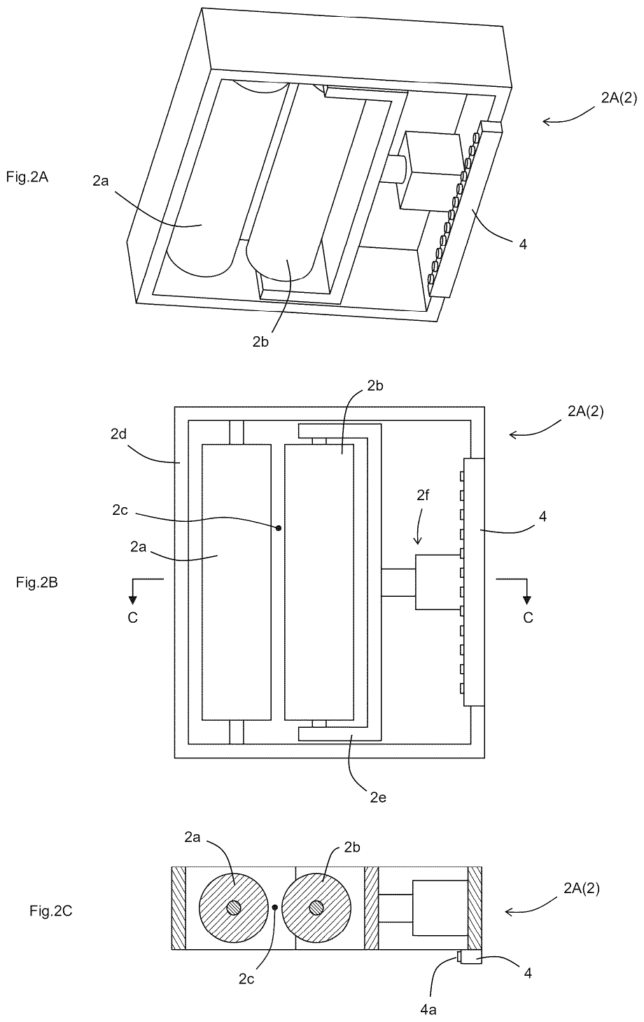

FIG. 3 is a cross-sectional view showing configurations of a mold 3B and a mold frame 3C.

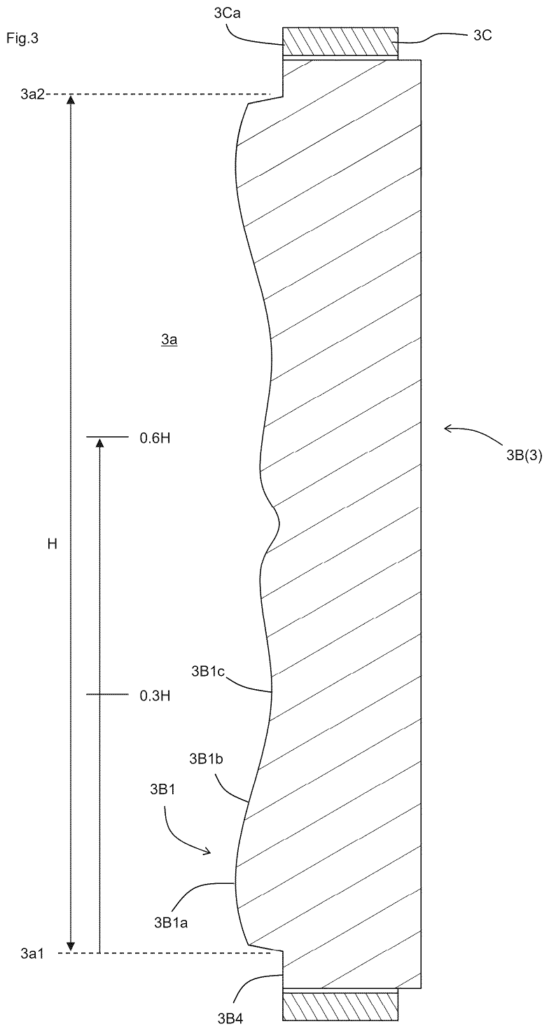

FIG. 4 shows a cross-sectional view of the state after the hanging step in the method of manufacturing a molded body.

FIG. 5 shows a cross-sectional view after resin sheet 5A is brought into close contact with a mold 3A and resin sheet 5B is brought into close contact with a mold frame 3C from the state shown in FIG. 4.

FIG. 6 is a schematic cross-sectional view of the hanging step shown in FIG. 4, in which the resin sheet 5B approaches the mold 3B and rides up on the convex part 3B1 when the static eliminator 4 is not present.

### DESCRIPTION OF EMBODIMENTS

Hereinafter, embodiments of the present invention will be explained by using drawings. Various distinctive features shown in the following embodiments can be combined with each other. In addition, an invention can be established independently for each of the distinctive features.

### 1. The First Embodiment

### 1-1 Configuration of a Molding Device 100

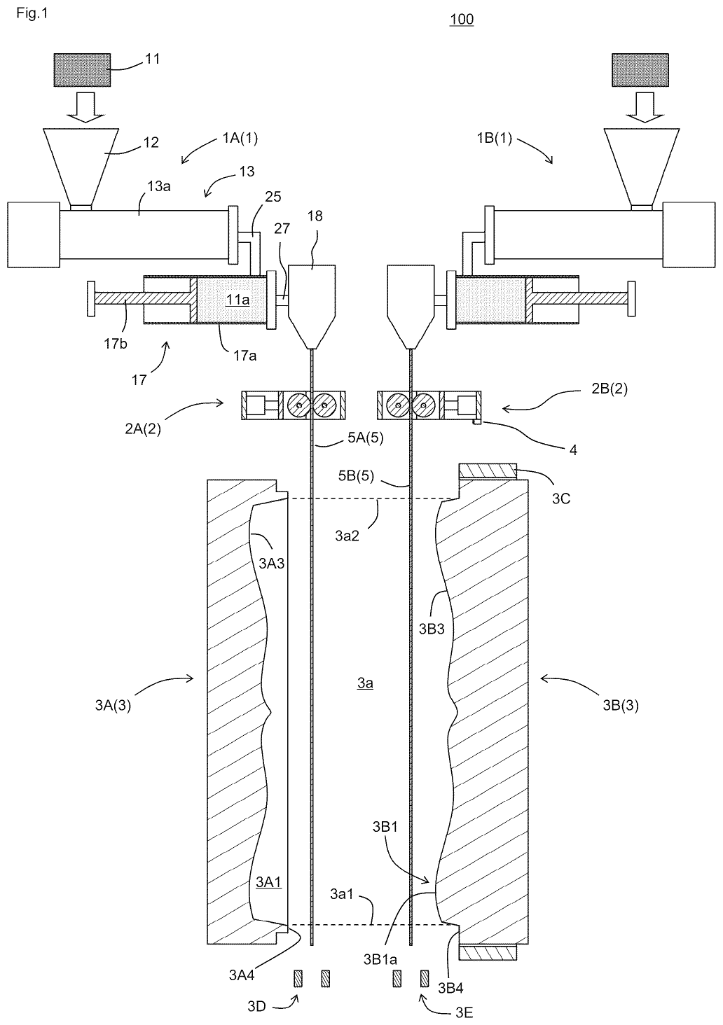

As shown in FIG. 1, a molding device 100 of one embodiment of the invention comprises a pair of resin sheet forming devices 1, a pair of roller units 2, a mold unit 3, and a static eliminator 4. The pair of resin sheet forming devices 1 will be marked with subscripts A, B, as in 1A, 1B, when they need to be distinguished from each other. The same applies to the roller unit 2 and a resin sheet 5.

### <Resin Sheet Forming Device 1>

The resin sheet forming device 1 is configured to extrude the resin sheet 5 in a molten state. The resin sheet forming device 1 comprises, in one example, a hopper 12, an extruder 13, an accumulator 17, and a T die 18. The extruder 13 and the accumulator 17 are connected via a connecting tube 25. The accumulator 17 and the T die 18 are connected via connecting a tube 27. The accumulator 17 can be omitted if it is not needed, in which case the molten resin extruded from the extruder 13 is directly injected into the T die 18.

The hopper 12 is used to feed raw resin 11 into a cylinder 13a of the extruder 13. The form of the raw resin 11 is not particularly limited, but is usually in the form of pellets. The raw resin is, for example, a thermoplastic resin such as polyolefin. Polyolefin includes low-density polyethylene, linear low-density polyethylene, high-density polyethylene, polypropylene, ethylene-propylene copolymers and blends thereof. The raw resin 11 is fed from the hopper 12 into the cylinder 13a and then heated in the cylinder 13a to melt it to be the molten resin. It is also conveyed toward the end of the cylinder 13a by the rotation of a screw positioned in the cylinder 13a. The screw is positioned inside the cylinder 13a and conveys the molten resin while kneading it by its rotation. The molten resin extruded from the resin extrusion port of the cylinder 13a is injected into the accumulator 17 through the connecting tube 25. The accumulator 17 comprises a cylinder 17a and a piston 17b that can slide inside the cylinder 17a, and the molten resin 11a can be stored in the cylinder 17a. After a predetermined amount of the molten resin 11a is stored in the cylinder 17a, the piston 17b is moved to extrude the molten resin 11a through the connecting tube 27 through a slit in the T die 18 and allow it to hang down to form the resin sheet 5 in a molten state.

### <Roller Unit 2>

The roller unit 2 is located between the resin sheet forming device 1 and the mold unit 3. The roller unit 2 comprises first and second rollers 2a and 2b. The rollers 2a and 2b are configured to rotate in opposite directions while sandwiching the resin sheet 5 so as to feed the resin sheet 5 below the rollers 2a and 2b. Preferably, gap 2c between the rollers 2a and 2b is configured to be variable, so that the resin sheet 5 can be sandwiched by the rollers 2a and 2b by placing the resin sheet 5 between the rollers 2a and 2b with the gap 2c widened and then narrowing the gap 2c. The roller 2a is a fixed roller with a fixed position, and the roller 2b is a movable roller with a variable distance from the roller 2a.

The roller unit 2 comprises a frame 2d, a movable roller supporting part 2e, and a drive mechanism 2f. The frame 2d is open at the top and bottom so that the resin sheet 5 can pass through. The rollers 2a and 2b are arranged in the frame 2d. One of the rollers 2a and 2b is configured to be rotatably driven by a rotary drive mechanism (not shown) attached to the frame 2d. The rotation of one of the rollers 2a and 2b can be transmitted to the other of the rollers 2a and 2b via a gear mechanism (not shown) in the opposite direction of rotation. Thus, the rollers 2a and 2b can rotate synchronously in opposite directions and feed the resin sheet 5 downward. For example, when the rotary drive mechanism drives the roller 2b, the rotation applied to roller 2b is transmitted to the roller 2a via the gear mechanism.

The roller 2b is rotatably supported by the movable roller supporting part 2e, and the movable roller supporting part 2e is movable by the drive mechanism 2f. The drive mechanism 2f is configured with a cylinder mechanism or the like, and the size of the gap 2c can be changed by moving the movable roller supporting part 2e.

Rotating the rollers 2a and 2b in opposite directions while sandwiching the resin sheet 5 between the rollers 2a and 2b enables the resin sheet 5 to be fed below the rollers 2a and 2b. At this time, the resin sheet 5 is charged by friction between the resin sheet 5 and the rollers 2a and 2b. This charging is more pronounced when the humidity is low.

### <Mold Unit 3>

The mold unit 3 comprises first and second molds 3A and 3B configured to be opened and closed. The molds 3A and 3B comprise shaping surfaces 3A3 and 3B3, respectively, to shape the resin sheet 5. The shaping surfaces 3A3 and 3B3 are provided in a molding area 3a to form a desired molded body. In this embodiment, the area surrounded by parting surfaces 3A4 and 3B4 is the molding area 3a.

More specifically, a first resin sheet 5A extruded from a first resin sheet forming device 1A and passing through a first roller unit 2A is hung down in a position adjacent to the mold 3A, and is vacuumed by the mold 3A under reduced pressure and shaped into a shape along the shaping surface 3A3. On the other hand, a second resin sheet 5B extruded from a second resin sheet forming device 1B and passing through a second roller unit 2B is hung down in a position adjacent to the mold 3B, and is vacuumed by the mold 3B under reduced pressure and shaped into a shape along the shaping surface 3B3.

When the molds 3A and 3B are then closed, the resin sheets 5A and 5B are welded together at the parting surfaces 3A4 and 3B4 of the molds 3A and 3B, and the desired molded body is formed in the molding area 3a which is the inside of an area surrounded by the parting surfaces 3A4 and 3B4.

The mold 3B has a convex part 3B1 and the mold 3A has a concave part 3A1 that can accommodate the convex part 3B1. In this embodiment, the convex part 3B1 is a portion protruding further than the parting surface 3B4.

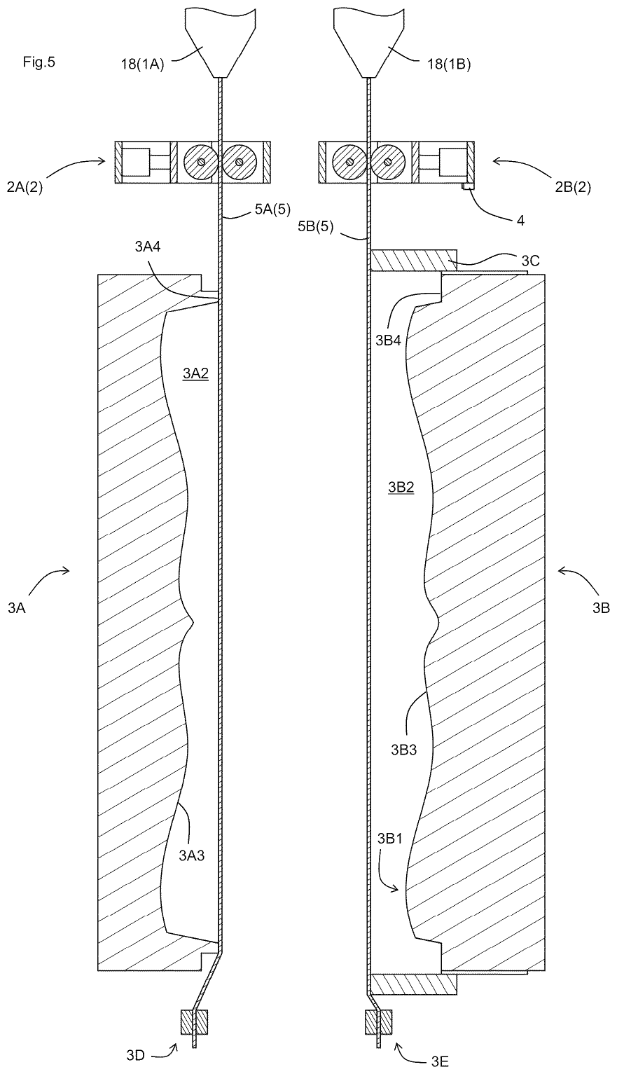

The mold unit 3 comprises a mold frame 3C arranged around the mold 3B. The mold frame 3C comprises a suctioning surface 3Ca capable of suctioning the resin sheet 5B. The mold frame 3C is configured to advance toward the resin sheet 5B to suction the resin sheet 5B as shown in FIG. 5, and then retract relative to the mold 3B (i.e., the mold frame 3C retracts and/or the mold 3B advances) to press the resin sheet 5B against the convex part 3B1.

The mold unit 3 comprises first and second sheet holding parts 3D and 3E positioned below the molds 3A and 3B. After holding the resin sheets 5A and 5B, respectively, the sheet holding parts 3D and 3E press the resin sheets 5A and 5B against the molds 3A and 3B by moving in the respective opening directions of the molds 3A and 3B. As shown in FIG. 5, this forms sealed space 3A2 surrounded by the resin sheet 5A and the mold 3A, and sealed space 3B2 surrounded by the resin sheet 5B, the mold frame 3C, and the mold 3B, thereby improving the shapability of the molds 3A and 3B by vacuuming with reduced pressure.

By the way, the range within which the mold frame 3C can move is limited, and the resin sheet 5B need to hang down at a position that the mold frame 3C can reach. Therefore, it is usually difficult to make the gap between the resin sheet 5B and a top 3B1a of the convex part 3B1 excessively large, and this gap is usually set at 10 to 30 mm (preferably 15 to 25 mm).

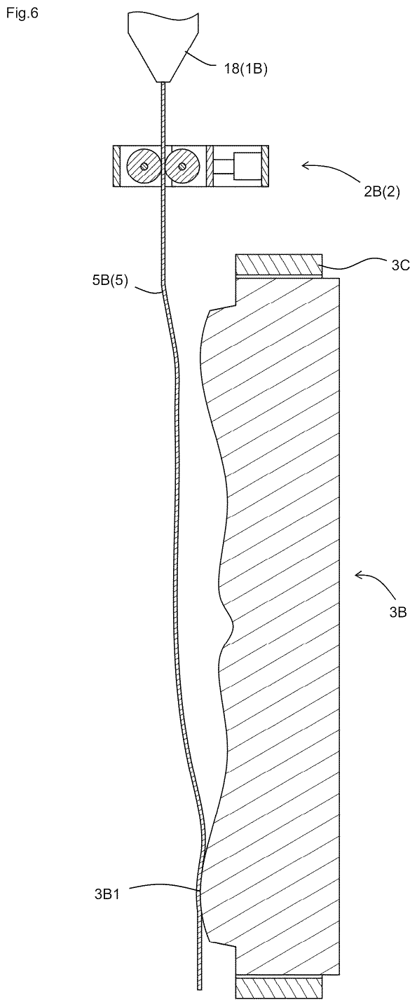

When the resin sheet 5B is not charged, the resin sheet 5B is not attracted to the mold 3B. However, when the resin sheet 5B is charged, the resin sheet 5B may be unintentionally attracted to the mold 3B by electrostatic force and ride up on the convex part 3B1, as shown in FIG. 6. When the resin sheet 5B rides up on the convex part 3B1, the slack of the resin sheet 5B increases, and as a result, folded walls may be generated in the resin sheet 5B where the inner surfaces stick to each other. The folded wall of the resin sheet 5B may not disappear even after shaping the resin sheet 5B, resulting in molding defects. To suppress the occurrence of such problems, In this embodiment, static is eliminated from the resin sheet 5B. The static eliminator 4 for eliminating static is described below.

The top 3B1a of the convex part 3B1 is preferably located at a height of 0.3H or less from a lower end 3a1 of the molding area 3a, where H is total height of the molding area 3a. When the top 3B1a is at a lower position, the length of the resin sheet 5B at the point where the resin sheet 5B has descended to a position opposite the top 3B1a is longer, and thus the resin sheet 5B is more likely to move and be attracted to the mold 3B by the electrostatic force. For this reason, the technical significance of applying the present invention is particularly significant when the top 3B1a is at the above position. The position of the top 3B1a may be, for example, 0.01H, 0.05H, 0.1H, 0.15H, 0.2H, 0.25H, 0.3H, and may be in the range between any two of the values illustrated here or below any of them.

It is preferred that an inclined surface 3B1b is provided at an upper side of the top 3B1a of the convex part 3B1, that the amount of protrusion of the inclined surface 3B1b gradually decreases upward. When the inclined surface 3B1b is provided at this portion, the resin sheet 5B can easily ride up on the convex part 3B1 when the resin sheet 5B is attracted to the mold 3B, and the technical significance of applying the present invention is particularly significant in such a case.

The location of a top edge 3B1c of the convex part 3B1 (e.g., the top edge 3B1c of the inclined surface 3B1b in this embodiment) is preferably located 0.6H or less from the lower end 3a1 of the molding area 3a. This is because in this case, the resin sheet 5B is particularly easy to ride up on the convex part 3B1. The position of the top edge 3B1c may be, for example, 0.1H, 0.2H, 0.3H, 0.4H, 0.5H, 0.6H, and may be in the range between any two of the values illustrated here or below any of them. The top edge 3B1c is the position where the protrusion of the convex part 3B1 ceases to change upward or becomes larger. There is no convex part 3B1 or another convex part 3B1 is provided at an upper side of the top edge 3B1c.

The convex part 3B1 has amount of protrusion relative to the parting surface 3B4 of, for example, 5 to 50 mm. This amount of protrusion is preferably between 5 and 20 mm, specifically, for example, 5, 10, 15, 20, 25, 30, 35, 40, 45, 50 mm, and may be in the range between any two of the values illustrated here.

When the amount of protrusion relative to the parting surface 3B4 at the top 3B1a is P1 and the amount of protrusion relative to the parting surface 3B4 at the top edge 3B1c is P2, P1 or (P1-P2) is preferably 5 to 50 mm, more preferably 5 to 20 mm, specifically, for example, 5 10, 15, 20, 25, 30, 35, 40, 45, 50 mm, and may be in the range between any two of the values illustrated here.

The mold 3B may have a plurality of convex parts 3B1, in which case at least one convex part 3B1 (e.g., the lowest convex part 3B1) should have the above configuration.

### <Static Eliminator 4>

The static eliminator 4 is configured to eliminate static from the resin sheet 5B at a point after the resin sheet 5B pass through the roller unit 2B but before the bottom edge of the resin sheet 5B reaches the lower end 3A1 of the molding area 3a. This prevents the resin sheet 5B from being attracted to the mold 3B.

The timing at which the static eliminator 4 eliminates static is preferably at a point before the bottom edge of the resin sheet 5B reaches the top 3B1a of the lowest convex part 3B1, more preferably at a point before an upper end 3a2 of the molding area 3a is reached, and even more preferably immediately after the resin sheet 5B has passed the roller unit 2B. In this case, the resin sheet 5B is particularly restrained from being attracted to the mold 3B.

The static eliminator 4 can eliminate static from the resin sheet 5B by irradiating the resin sheet 5B with ions emitted from a ion emitter 4a. The irradiated ions have a charge opposite to the charge carried by the resin sheet 5B, and the charge of the resin sheet 5B is combined with the charge of the ions to eliminate static from the resin sheet 5B. For example, if the resin sheet 5B has a negative charge, it can be irradiated with positively charged ions. Although some static eliminators 4 irradiate the object with an air current of ions, it is preferable to operate the static eliminator 4 without an air current, because irradiating the resin sheet 5B with an air current may cause the resin sheet 5B to cool down and worsen its shapability. An example of the static eliminator 4 is the model SJ-H108A manufactured by Keyence Corporation.

The static eliminator 4 is preferably placed between the roller unit 2B and the mold unit 3, and is preferably attached to underside of the frame 2d of the roller unit 2B directly or via other component. In this case, the static eliminator 4 can be placed in a position where the resin sheet 5B can be eliminated static immediately after the resin sheet 5B passes through the roller unit 2B. The static eliminator 4 is preferably elongated and arranged so that the longitudinal direction of the static eliminator 4 is parallel to the longitudinal direction of the rollers 2a and 2b.

The length between the resin sheet 5B and the static eliminator 4 is, for example, 200 to 500 mm, specifically, for example, 200, 250, 300, 350, 400, 450, 500 mm, and may be in the range between any two of the values illustrated here.

In this embodiment, the static eliminator 4 is provided for static elimination only of the resin sheet 5B, but if necessary, another static eliminator 4 may be separately provided for static elimination of the resin sheet 5A.

### 1-2. Method of Manufacturing Molded Body

Next, the method of manufacturing the molded body using the molding device 100 will be described.

The method of manufacturing in this embodiment comprises a hanging step and a molding step. The following is a description of these steps.

### (1) Hanging Step

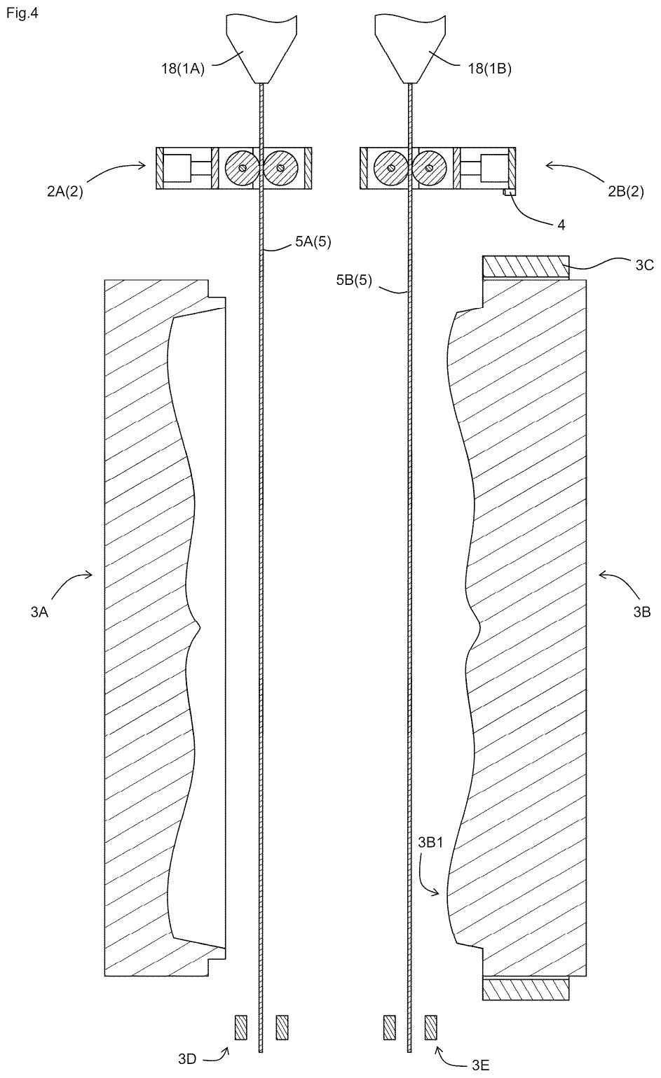

In the hanging step, as shown in FIG. 4, the first resin sheet 5A extruded from the T die 18 of the first resin sheet forming device 1A and passed through the first roller unit 2A is hung down in a position adjacent to the mold 3A. The second resin sheet 5B extruded from the T die 18 of the second resin sheet forming device 1B and passed through the second roller unit 2B is hung down in a position adjacent to the mold 3B.

When the resin sheet 5B is charged, the resin sheet 5B may be attracted to the mold 3B (especially the convex part 3B1) and ride up on the convex part 3B1, as shown in FIG. 6, but in this embodiment, the static eliminator 4 eliminates static from the resin sheet 5B in the space between the roller unit 2B and the mold 3B, so the resin sheet 5B hangs down without being attracted to the mold 3B.

### (2) Molding Step

In the molding step, as shown in FIG. 5, the mold 3A is brought closer to the resin sheet 5A and the holding part 3D is moved in the opening direction of the mold 3A (left direction in FIG. 5) with the resin sheet 5A held by the holding part 3D, so that the resin sheet 5A is brought into close contact with the parting surface 3A4 of the mold 3A. In addition, the mold frame 3C is brought closer to the resin sheet 5B, and the holding part 3E is moved in the opening direction of the mold 3B (right direction in FIG. 5) with the resin sheet 5B held by the holding part 3E, so that the resin sheet 5B is brought into close contact with the mold frame 3C. This forms the sealed space 3A2 surrounded by the resin sheet 5A and the mold 3A, and the sealed space 3B2 surrounded by the resin sheet 5B, the mold frame 3C, and the mold 3B.

Next, the resin sheet 5A is shaped into a shape along the shaping surface 3A3 of the mold 3A by vacuuming the resin sheet 5A with the mold 3A under reduced pressure. Also, by retracting the mold frame 3C relative to the mold 3B, the resin sheet 5B is pressed against the mold 3B (especially, the convex part 3B1), and the resin sheet 5B is shaped into a shape along the shaping surface 3B3 of the mold 3B by vacuuming the resin sheet 5B with the mold 3B under reduced pressure.

Next, when the molds 3A and 3B are closed, the resin sheets 5A and 5B are welded together at the parting surfaces 3A4 and 3B4 of the molds 3A and 3B, and the desired molded body is formed in the molding area 3a which is the inside of an area surrounded by the parting surfaces 3A4 and 3B4. Burrs are formed on the outside of the molding area 3a. The molds 3A and 3B are then opened to remove the molded body with burrs, and post-processing such as burr removal is performed to obtain the desired molded body. The molded body is a hollow molded body, but may also be a solid molded body. The molded body may be either a foamed or non-foamed molded body.

### 2. Other Embodiments

In the above embodiment, the molding device 100 is a device that molds using two resin sheets 5A and 5B, but the molding device 100 may also be a device that molds using one resin sheet 5. In this case, the molding device 100 needs to comprise with one resin sheet forming device 1 and one roller unit 2. Since the molds 3A and 3B can form the resin sheet 5 by sandwiching the resin sheet 5 between the molds 3A and 3B, the molds 3A and 3B do not need to vacuum the resin sheet 5 under reduced pressure.

In the above embodiment, the molding device 100 comprises the first and second molds 3A and 3B. Alternatively, the molding device 100 may comprise only the second mold 3B and enable molding of the resin sheet 5B by vacuum molding with reduced-pressure suction. In this case, the area where the shaping surface 3B3 to shape the desired molded body is provided is the molding area 3a, and the part surrounding the molding area 3a is the base part (corresponding to the parting surface 3B4). The convex part 3B1 is preferably a portion protruding more than the base portion, more preferably the most protruding portion in the second mold 3B. Even in such an embodiment, the static elimination of the resin sheet 5B by the static eliminator 4 prevents the resin sheet 5B from being attracted to the mold 3B. In this embodiment, the first “second” in the component name may be omitted because the resin sheet forming device, the roller unit, the resin sheet, the mold, and the sheet holding part are each single in this embodiment.

### REFERENCE SIGN LIST

1: resin sheet forming device, 1A: first resin sheet forming device, 1B: second resin sheet forming device, 2: roller unit, 2A: first roller unit, 2B: second roller unit, 2a: first roller, 2b: second roller, 2c: gap, 2d: frame, 2e: movable roller supporting part, 2f: drive mechanism, 3: mold unit, 3A: first mold, 3A1: concave part, 3A2: sealed space, 3A3: shaping surface, 3A4: parting surface, 3B: second mold 3, 3B1: convex part, 3B1a: top, 3B1b: inclined surface, 3B1c: top edge, 3B2: sealed space, 3B3: shaping surface, 3B4: parting surface, 3C: mold frame, 3Ca: suctioning surface, 3D: first sheet holding part, 3E: second sheet holding part, 3a: molding area, 3a1: lower end, 3a2: upper end, 4: static eliminator, 4a: ion emitter, 5: resin sheet, 5A: first resin sheet, 5B: second resin sheet, 11: raw resin, 11a: molten resin, 12: hopper, 13: extruder, 13a: cylinder, 17 accumulator, 17a: cylinder, 17b: piston, 18: T die, 25: connecting tube, 27: connecting tube, 100: molding device.

1. A molding device comprising a resin sheet forming device, a roller unit, a mold, and a static eliminator, wherein:
the resin sheet forming device is configured to extrude a resin sheet in a molten state;
the roller unit comprises first and second rollers;
the first and second rollers are configured to rotate in opposite directions while sandwiching the resin sheet so as to feed the resin sheet below the first and second rollers;
the mold has a shaping surface to shape the resin sheet; and
the static eliminator is configured to eliminate static from the resin sheet at a point after the resin sheet passes through the roller unit but before a bottom edge of the resin sheet reaches a lower end of a molding area of the mold.

2. The molding device according to claim 1, wherein:
the mold comprises a convex part in the molding area.

3. The molding device according to claim 2, wherein:
a top of the convex part is located at a height of 0.3H or less from the lower end of the molding area, where H is total height of the molding area.

4. The molding device according to claim 3, wherein:
an inclined surface is provided at an upper side of the top of the convex part; and
the amount of protrusion of the inclined surface gradually decreases upward.

5. The molding device according to claim 2, comprising a mold frame arranged around the mold, wherein:
the mold frame comprises a suctioning surface capable of suctioning the resin sheet,
the mold frame is configured to advance toward the resin sheet to suction the resin sheet and then retract relative to the mold to press the resin sheet against the convex part.

6. The molding device according to claim 1, wherein:
the roller unit comprises a frame that houses the first and second rollers, and
the static eliminator is attached to underside of the frame directly or via other component.
